(19) United States
(12) Patent Application Publication
(10) Pub. No.: US 2002/0076048 A1
(43) Pub. Date: Jun. 20, 2002

(54) System and method for inserting disruptions into merged digital recordings

(75) Inventor: Laszlo Hars, Cortlandt Manor, NY (US)

Correspondence Address: Jack E. Haken, Corporate Patent Counsel, Philips Electronics North America Corporation, 580 White Plains Road, Tarrytown, NY, 10591, US

(73) Assignee: PHILIPS ELECTRONICS NORTH AMERICA CORPORATION

(21) Appl. No.: 09/747,513

(22) Filed: Dec. 20, 2000

(51) Int. Cl. H04L 9/00

(52) U.S. Cl. 380/205; 713/176

(57) ABSTRACT

A system and method for preventing the illicit copying and processing of digital recordings. In particular, the system inhibits the merging or stitching together of fragments of a digital recording in order to defeat a protection scheme. To accomplish this, the invention provides a compliant device having a system for merging digital recordings and which comprises a system for receiving a first digital recording and a second digital recording; and a system for merging the first digital recording and the second digital recording into an output, wherein the output includes a disruption between the first digital recording and the second digital recording. Attempts at recording stitched together fragments will thus result in an outputted recording having disruptions, which will cause frequent interruptions or loudness fluctuations during playback.

### BACKGROUND OF THE INVENTION

1. Technical Field

The present invention relates generally to security systems for digital recordings, and more particularly relates to anti-pirating schemes for controlling the copying, playing, and distribution of digital music.

2. Related Art

The popularity of both the Internet and digital media technologies (e.g., compact disks “CD's” and digital versatile disks “DVD's”) has created tremendous problems for copyright owners of digital media content. The ability to reproduce, play and transmit digital content has become readily available to anyone with a personal computer and access to the Internet. This ability has led to widespread abuses to the rights of copyright owners who are unable to stop the illegal reproduction of their works.

One particular area where copyright ownership is particularly abused involves the music industry. The illicit pirating of digital music across the Internet is causing immeasurable damages to the music industry. Heretofore, most music content has been packaged and stored in an open, unsecured format that can be read and processed by any digital media player or recorder, i.e., content can be readily reproduced, stored and transmitted. To address this, the music industry has sought to create a secure domain to control the rampant pirating of music.

One solution the music industry is exploring involves establishing standards for secure playback and recording devices that process specially encoded content. Numerous secure devices and systems have been proposed. For instance, U.S. Pat. No. 5,513,260, issued on Apr. 30, 1996, entitled, Method and Apparatus For Copy Protection For Various Recording Media, describes a system in which an authorization signature is required before a protected CD can be played. PCT application WO 99/60568, published on Nov. 25, 1999, entitled, Copy Protection Using Broken Modulation Rules, also discloses various anti-pirating systems. Each of these references is hereby incorporated by reference.

In addition, a group referred to as SDMI (Secure Digital Music Initiative), made up of more than 180 companies and organizations representing information technology, consumer electronics, telecommunication, security technology, the worldwide recording industry, and Internet service providers, is attempting to develop standards and architectures for secure delivery of digital music in all forms. Information regarding SDMI can be found at their website at <www.sdmi.org>.

One of the challenges with implementing compliant systems, such as those sought under SDMI, is that various competing requirements must be met. For instance, under SDMI: (1) people must be allowed to make an unlimited number of personal copies of their CDs if in possession of the original CD; (2) SDMI-compliant players must be able to play music already in a library; (3) SDMI must provide the ability to prevent large numbers of perfect digital copies of music; and (4) SDMI must prevent the distribution on the Internet without any compensation to the creator or copyright holder. Thus, SDMI requires that a limited form of copying must be allowed, while at the same time widespread copying must be prohibited.

Unfortunately, such competing requirements create opportunities for hackers and pirates to defeat the protection schemes of the systems. Accordingly, protection schemes that are difficult to defeat, but will meet the open requirements for initiatives such as SDMI, must be developed.

### SUMMARY OF THE INVENTION

This invention addresses the above-mentioned problems, as well as others, by providing a system and method for preventing the illicit copying and processing of digital recordings. In particular, the system inhibits the merging or stitching together of fragments of a digital recording in order to defeat a protection scheme.

In a first aspect, the invention provides a device for processing a watermarked digital recording, comprising: a verification system for verifying the watermarked digital recording; and an insertion system for inserting a disruption along with the watermarked digital recording.

In a second aspect, the invention provides a system for editing digital recordings, comprising: a system for receiving a first digital recording and a second digital recording; and a system for merging the first digital recording and the second digital recording into an output, wherein the output includes a disruption between the first digital recording and the second digital recording.

In a third aspect, the invention provides a method for editing a first and a second digital recording, comprising the steps of: merging the first and the second digital recordings; and generating an output, wherein the output includes a disruption between the first and the second digital recordings.

It is therefore an advantage of the present invention to provide a system that prevents the illicit pirating of digital recordings by not allowing segments or fragments of a digital recording to be stitched together.

It is a further advantage of the present invention to provide a system in which filler is inserted between recorded segments in order to limit the usability of an illegally processed recording.

### BRIEF DESCRIPTION OF THE DRAWINGS

The preferred exemplary embodiment of the present invention will hereinafter be described in conjunction with the appended drawings, where like designations denote like elements, and:

FIG. 1 depicts a block diagram of an anti-pirating system in accordance with a preferred embodiment of the present invention.

FIG. 2 depicts a graphical representation of a digital recording.

FIG. 3 depicts a graphical representation of a watermarked digital recording.

FIG. 4 depicts a block diagram of the compliant device of FIG. 1 inserting silence between merged sections.

FIG. 5 depicts a block diagram of the compliant device of FIG. 1 that comprises amplitude modulation of merged sections.

It should be understood that the Figures are presented for the purposes of illustration only, and are not necessarily drawn to scale. As such, the Figures should not be considered limiting on the scope of the invention.

### DETAILED DESCRIPTION OF THE INVENTION

1. Overview

The present invention provides a system and method for protecting digital recordings from illicit processing. The term “processing,” as used herein, may include any type of reproduction, transmission, playback, modification, etc., of a digital recording. The term “digital recording” may include any type of information, data, music, video, multimedia, etc. that can be stored in a digital format. One method for accomplishing protection is to first verify that a complete data set of the digital recording be present before processing can occur. For example, in the music industry, music is typically delivered on an audio CD that comprises a collection of tracks or songs. The present invention may utilize a system and method that requires the complete collection of tracks to be present before processing. Since illicit music copying is often limited to a small subset of the songs on a CD, the ability to illegally post and download individual songs from the Internet would be substantially limited.

Accordingly, some of the exemplary embodiments described herein verify the presence of the whole medium (or entire collection of data as originally distributed) at the time of processing as proof of legal ownership. If a portion of the medium is not present, the processing of the digital recording can be aborted. Although one important application of this invention relates to the delivery of music content, it should be understood that the invention has applications to any type of digital recording that has a plurality of tracks. For the purposes of this disclosure, “a plurality of tracks” shall be defined to include any digital recording that has more than one individually usable or desirable segment.

2. Verification

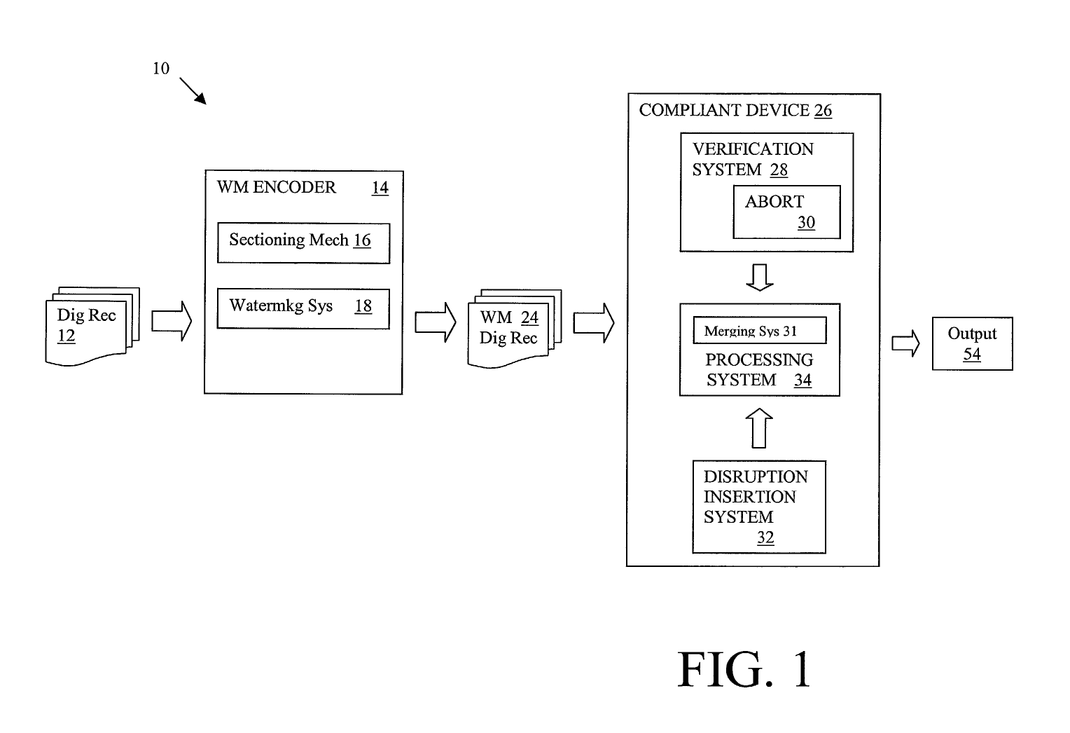

Referring to FIG. 1, an exemplary anti-pirating system 10 is shown that prevents the illicit processing of digital data by verifying the data before it can be processed, e.g., recorded, transmitted, played, etc. Verification is accomplished by first converting a digital recording 12 into a watermarked digital recording 24 using watermark encoder 14. A compliant device 26, which comprises a system compliant with watermark encoder 14, can then be used to verify the watermarked digital recording 24. Once verified, compliant device 26 can proceed with processing (e.g., copying or recording) of the watermarked digital recording 24 to generate output 54.

A preferred system and method for encoding a digital recording 12 involves partitioning the digital recording into a plurality of small sections (e.g., 15 second long sections) using sectioning mechanism 16, and then watermarking digital recording 12 with watermarking system 18. Watermarking may involve, for example, marking some or all of the sections with a calculated identifier or watermark that captures a salient feature of the entire digital recording. For example, an identifier W may be calculated as a hash H of the data in each section S1, S2, . . . Sn, that is, W=H(S1, S2, . . . Sn).

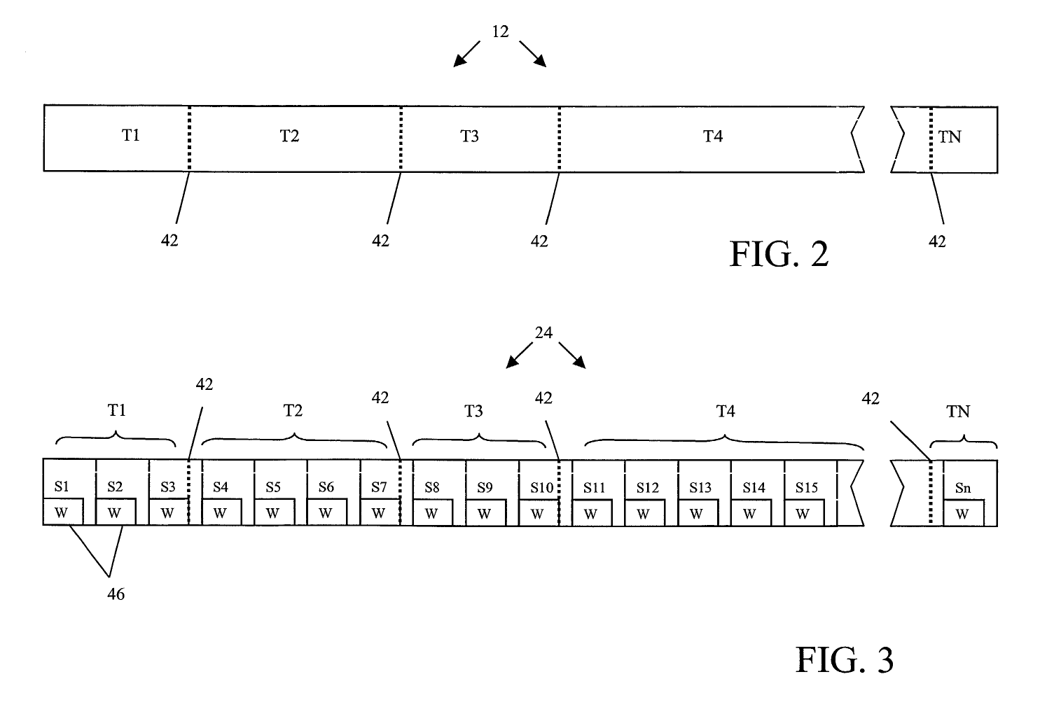

FIGS. 2 and 3 depict a graphical representation of digital recording 12 and watermarked digital recording 24. Digital recording 12 comprises a plurality of tracks T1, T2 . . . TN, delimited by endpoints 42. Watermarked digital recording 24 includes the plurality of tracks T1, T2 . . . TN of digital recording 12, but is further partitioned into a plurality of sections S1, S2, . . . Sn. In addition, each of the sections contains a watermark W 46. It should be understood that watermarked digital recording 24 of FIG. 3 represents only one exemplary watermark encoding strategy. Other implementations, such as watermarking a subset of the sections, or partitioning the watermark into several sections, could likewise be utilized, and fall within the scope of the invention.

The term “watermark” as used herein can refer to any type of watermark, including multiple simple watermarks or robust watermarks. Multiple simple watermarks can be fragile, meaning that the watermark disappears if the content is manipulated in a way not explicitly allowed (e.g. compression). Alternatively, robust watermarks survive all manipulations of the content that do not degrade the content quality. These watermarks can carry copyright information and the policy associated with the content, e.g., whether the content can be copied. Accordingly, the policy may be: “content can be copied, only if the complete data set of the original medium is present.”

Before processing, compliant device 26 utilizes a verification system 28 that verifies watermarked digital recording 24. For instance, in the case described above, verification system 28 can verify watermarked digital recording 24 by first portioning the recording 24 into sections S1′, S2′, .. . Sn′; recalculating the identifier W′=H(S1′, S2′, . . . Sn′); and comparing the identifier W′ with a watermark W″ extracted from one of the sections S1′, S2′, . . . Sn′. If W′=W″, the particular section is verified. The process can then be repeated for each section. If all of the sections of the entire watermarked digital recording 24 are verified, processing system 34 will process recording 24. If one or more of the sections are not verified, processing will be aborted by abort mechanism 30.

Thus, system 10 provides an exemplary scheme in which the presence of the entire recording 24 is required before processing will be allowed. It is however understood that any variation of a verification system in which an attempt is made to verify a digital recording falls within the scope of this invention.

3. Disruption Insertion

Because verification system 28 relies on detecting watermarks, it is possible to diminish the efficacy of verification system 28 by attempting to individually process small fragments of the watermarked digital recording 24. Such small fragments may be too short for the watermark to be recognized, thus giving the appearance that, for instance, the content is not copyrighted (i.e., it comprises legacy content) and should be processed. For example, assume that compliant device 26 was a recording mechanism and watermarked digital recording 12 was an illegal copy of a single song. Because the entire CD is not present, recording of the entire song would be aborted since one or more sections from the song would not be properly verified. To circumvent this, a pirate, acting in a secure domain, could try to stitch or merge individually recorded song fragments. Specifically, one could try to: (1) divide the song into a plurality of fragments (e.g., a section, a few sections, or portions of sections); (2) separately input individual fragments into compliant device 26; (3) attempt to record each fragment individually; and (4) reset the recording equipment after each successful recording and repeat until a complete song has been recorded.

Although such a stitching process is not without its challenges, the probability of a successful recording would be far greater than merely trying to record the entire song. For instance, assume that the illicit song contained k sections, and that the odds of any given section randomly being verified was P. Then, the odds of all of the sections of the song being randomly verified would be P^{k}. Thus, if a song contained 20 sections, and the probability of a random verification was 10%, then the odds of a successful recording would be 0.10²⁰=10⁻²⁰. Alternatively, under a “stitching” approach, if the odds of any single fragment randomly verifying was still P=10%, the pirate could potentially record a given fragment with 10 attempts. Thus, if the song were broken into 20 fragments, a pirate could potentially defeat the system in 10×20=200 attempts if allowed to merge together recorded fragments in the secure domain. This might be an acceptable price for defeating verification system 28, particularly if the process could be computerized.

To overcome the above circumvention scheme, the present embodiment comprises a disruption insertion system 32 in compliant device 26. Disruption insertion system 32 interfaces with processing system 34 and inserts some type of disruption at the beginning and/or end of any processed recording. Preferably, disruption insertion system 32 inserts a disruption between two recorded fragments anytime the fragments are merged together by merging system 31.

Two exemplary types of disruptions include: (1) insertion of a filler, and (2) amplitude modulation. In the case of filler insertion, some type of “filler” is contiguously inserted just prior to the beginning and/or immediately after the end, of any recording or processing. Filler may comprise, for example, silence inserted in between recorded segments or sections. Other types of filler may include a hum, an advertisement, a bell, a beep, etc. In addition, filler may include a combination of insertions, such as silence and a beep.

In the case of amplitude modulation, the disruption comprises a system wherein the power (i.e., sound level) is made slowly increasing at the beginning of the recording and/or slowly decaying at the end of the recording (i.e., fade in, fade out). The disruption would preferably modify only a fraction of a second of any legitimate recording, but would encourage users to start or stop recordings only at silence, where there would be no audible effect.

Accordingly, the disclosed embodiments provide a system wherein attempts at stitching together recordings would result in frequent interruptions or loudness fluctuations, and defeat the potential for pirating. It should be understood that any other types of disruptions, in addition to those discussed herein, could be used as long as they did not interfere with the legitimate editing of song collections. It should also be understood that term “merging” may include all facets of editing multiple recordings, including cutting, equalizing, inserting one fragment into another, concatenation, etc.

Preferably, the filler insertion and/or amplitude modulation are best implemented by merging system 31 when two recorded fragments are merged together. Moreover, in the secure domain, the recorded fragments are preferably encrypted in such a way that any efforts at contiguously attaching fragments results in an invalid encryption. Such encryption techniques, which result in an invalid cipher-text if encrypted fragments are concatenated, are well known in the art. Thus, the methodology of merging system 31 may involve decrypting the fragments, combining the fragments, and re-encrypting the resulting longer combination. So long as the encryption process is secure, control over any editing operations (e.g., merging system 31) is maintained by compliant device 26, and the user cannot simply strip out the disruption.

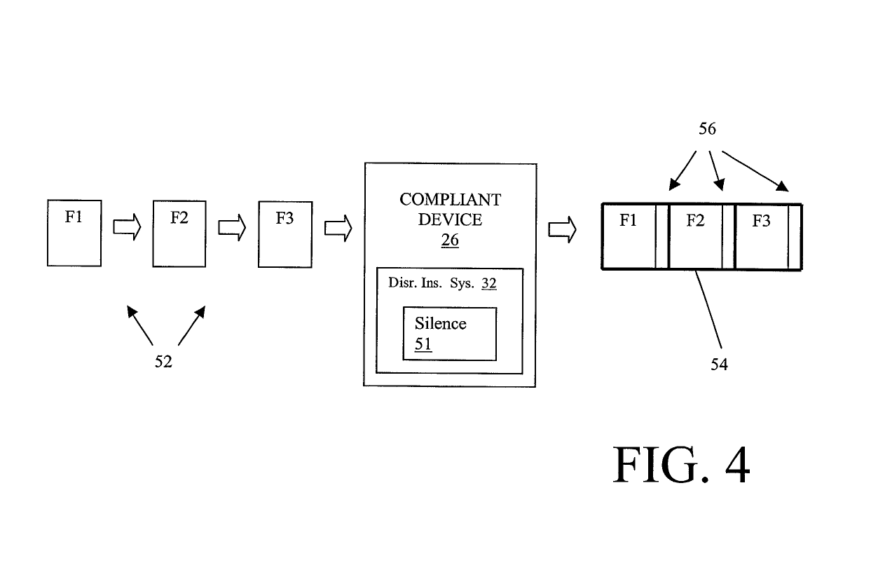

Referring to FIG. 4, an exemplary embodiment utilizing disruption insertion system 32 to insert silence is shown when an attempt is made to stitch together a plurality of recorded sections 52. As shown, each fragment F1, F2 and F3 are individually inputted into compliant device 26 for processing, in this case to be separately recorded and merged together to form output 54. However, because each section is processed separately, disruption insertion system 32 has inserted a small amount of contiguous dead space, or silence 56 after each section. Thus, the resulting output 54 comprises the recorded sections F1, F2, and F3 interleaved with silence 56. The resulting output 54 therefore is not suitable for listening or use since it contains numerous interruptions.

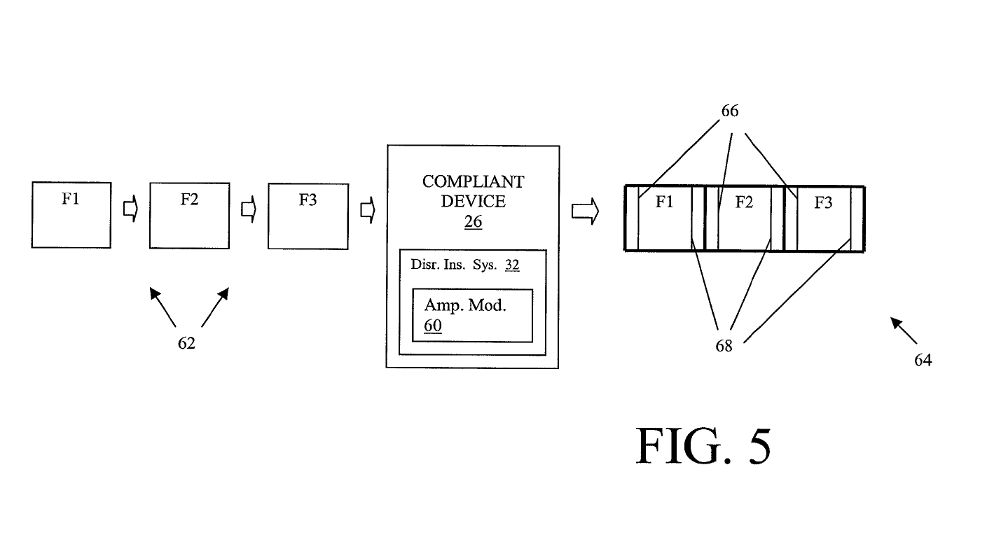

FIG. 5 depicts an exemplary embodiment in which the disruption insertion system 32 causes amplitude modulation 60 to insert a fade in/fade out at the beginning and ending of each processed fragment, respectively. As can be seen, fragments F1, F2 and F3 are inputted into compliant device 26 and a resulting output 64 is produced. Output 64 is comprised of the three fragments F1, F2 and F3, each slightly modified. In particular, a beginning portion 66 of each fragment is modified such that its power level is slowly increased, and an ending portion 68 of each fragment is modified such that its power level along is slowly decayed.

It is understood that the systems, functions, mechanisms, and modules described herein can be implemented in hardware, software, or a combination of hardware and software. They may be implemented by any type of computer system or other apparatus adapted for carrying out the methods described herein. A typical combination of hardware and software could be a general-purpose computer system with a computer program that, when loaded and executed, controls the computer system such that it carries out the methods described herein. Alternatively, a specific use computer, containing specialized hardware for carrying out one or more of the functional tasks of the invention could be utilized. The present invention can also be embedded in a computer program product, which comprises all the features enabling the implementation of the methods and functions described herein, and which—when loaded in a computer system - is able to carry out these methods and functions. Computer program, software program, program, program product, or software, in the present context mean any expression, in any language, code or notation, of a set of instructions intended to cause a system having an information processing capability to perform a particular function either directly or after either or both of the following: (a) conversion to another language, code or notation; and/or (b) reproduction in a different material form.

The foregoing description of the preferred embodiments of the invention have been presented for purposes of illustration and description. They are not intended to be exhaustive or to limit the invention to the precise form disclosed, and obviously many modifications and variations are possible in light of the above teachings. Such modifications and variations that are apparent to a person skilled in the art are intended to be included within the scope of this invention as defined by the accompanying claims.

I claim:

1. A device for processing a watermarked digital recording, comprising:
a verification system for verifying the watermarked digital recording; and
an insertion system for inserting a disruption with the watermarked digital recording.

2. The device of claim 1, wherein the device is a recording device.

3. The device of claim 1, wherein the verification system partitions the watermarked digital recording into a plurality of sections.

4. The device of claim 3, wherein the verification system compares a watermark value stored in at least one section with a salient value derived from the entire watermarked digital recording.

5. The device of claim 4, wherein the salient value is a hash of data contained in each of the plurality of sections.

6. The device of claim 1, wherein the disruption comprises a filler.

7. The device of claim 6, wherein the filler comprises silence.

8. The device of claim 6, wherein the filler is contiguously inserted before the watermarked digital recording.

9. The device of claim 6, wherein the filler is contiguously inserted after the watermarked digital recording.

10. The device of claim 1, wherein the disruption comprises an amplitude modulation.

11. The device of claim 10, wherein the amplitude modulation comprises an increasing power level at a beginning of the watermarked digital recording.

12. The device of claim 10, wherein the amplitude modulation comprises a decaying power level at an ending of the watermarked digital recording.

13. A system for merging digital recordings, comprising:
a system for receiving a first digital recording and a second digital recording; and
a system for merging the first digital recording and the second digital recording into an output, wherein the output includes a disruption between the first digital recording and the second digital recording.

14. The system of claim 13, wherein the first digital recording and the second digital recording are encrypted such that concatenating the first digital recording and the second digital recording will result in an invalid encryption.

15. The system of claim 14, wherein the system for merging further includes:
a system for decrypting the first and the second digital recording;
a system concatenating the first and the second digital recording into an decrypted output;
a system for inserting the disruption into the decrypted output; and
a system for re-encrypting the decrypted output.

16. The system of claim 13, further comprising a verification system for verifying watermarks in the first and second digital recordings.

17. The system of claim 16, wherein the verification system includes a system for aborting the creation of the output if the watermarks are not verified.

18. The system of claim 13, wherein the disruption comprises a filler.

19. The system of claim 13, wherein the disruption comprises an amplitude modulation.

20. A method for merging a first and a second digital recording, comprising the steps of:
verifying the first and the second digital recordings;
merging the first and the second digital recordings; and
generating an output, wherein the output include a disruption between the first and the second digital recordings.

21. The method of claim 20, wherein the verifying step includes comparing a watermark value inserted into at least one section of the digital recording with a salient value of the entire digital recording.

22. The method of claim 20, wherein the disruption includes a contiguously inserted filler.

23. The method of claim 20, wherein the disruption includes an amplitude modulation of at least one of the first and second digital recordings.

24. The method of claim 20, wherein the first and the second digital recordings are encrypted, and wherein the merging step includes the step of decrypting the first and second digital recordings, concatenating the first and second digital recordings with the disruption, and encrypting the output.
